(19) United States
(12) Patent Application Publication
(10) Pub. No.: US 2024/0422591 A1
(43) Pub. Date: Dec. 19, 2024

(54) COMMUNICATION GRID REDUNDANCY PROTOCOL

(71) Applicant: ESpace Networks, Inc., Dover, DE (US)

(72) Inventors: Brian Scott Kersey, Alpharetta (UA); Paul Vijay Manoharan, Chennai, IN (US)

(21) Appl. No.: 18/743,924

(22) Filed: Jun. 14, 2024

Related U.S. Application Data
(60) Provisional application No. 63/521,008, filed on Jun. 14, 2023.

(51) Int. Cl. H04W 24/04

(52) U.S. Cl. CPC H04W 24/04

(57) ABSTRACT

A communication system having plurality of access-point sites, each having a plurality of hubs, and a first vessel having a plurality of spokes, where each spoke is paired with a hub from the plurality of hubs such that a first spoke is paired with a first hub of each of the sites, and a second spoke is paired with the second hub of each of the sites. The first spoke is an active spoke and each other spoke is a backup spoke, such that a communication pathway from first spoke to the first hub a first site is an active communication pathway, and such that the first hub of the first site is an active hub and the first site is an active site. The system may further include a communications protocol wherein each spoke maintains a communication data set relating to communications parameters, which are communicated throughout the system.

### CROSS REFERENCE TO RELATED APPLICATIONS

This application claims priority to U.S. provisional patent application No. 63/521,008, filed on Jun. 14, 2024, the entire contents of which are incorporated by reference herein.

### FIELD

The present disclosure relates generally to a redundancy protocol for a communication grid.

### BACKGROUND

The modern world is becoming increasingly dependent on reliable communication systems for various applications, such as telecommunications, internet, energy distribution, and transportation. Communication networks, particularly those with a grid topology, play a crucial role in ensuring the seamless operation of these services. The resilience of communication networks to failures and their ability to recover and maintain functionality is of utmost importance, particularly in mission-critical applications and during natural disasters, accidents, or malicious attacks.

Traditional communication systems often employ various redundancy mechanisms to ensure high availability and fault tolerance. Common redundancy techniques include duplicating critical components, utilizing multiple network paths, or implementing backup power sources. While these approaches improve overall network reliability, they can also be costly, resource-intensive, and inefficient in terms of energy consumption and bandwidth usage.

The current state of the art in redundancy protocols for communication networks suffers from several limitations. Some protocols require extensive reconfiguration or manual intervention in response to failures, leading to extended downtimes and potential service disruptions. Other protocols focus solely on minimizing redundancy, sacrificing overall system reliability in the process. Additionally, existing redundancy protocols often do not consider the specific characteristics of a grid-based communication network, limiting their applicability and effectiveness in such systems.

To overcome these limitations, there is a need for an innovative communication grid redundancy protocol that is tailored to the unique requirements and constraints of grid-based communication networks. Such a protocol should be able to:
1. detect local (Spoke) and remote (Spoke to Hub) failures;
2. attempt to maintain connectivity to the primary site; and
3. prevent a split-brain scenario resulting in multiple active paths.

The present invention aims to address the aforementioned problems by providing a novel redundancy protocol designed specifically for communication grid networks. This protocol offers a comprehensive solution that balances reliability, efficiency, and adaptability, ensuring continuous operation in the face of network failures and other adverse conditions. The invention not only improves the resilience of grid-based communication systems but also has the potential to reduce operating costs and resource usage.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In one embodiment a communication system may include a plurality of access-point sites, including first site and a second site, wherein each of the sites of the plurality of sites may include a plurality of hubs including a first hub and a second hub. The communication system may further include a first vessel that may include a plurality of spokes, including a first spoke and a second spoke, where each spoke of the plurality of spokes is paired with a hub from the plurality of hubs such that the first spoke is paired with the first hub of each of the sites in the plurality of sites, and the second spoke is paired with the second hub of each of the sites in the plurality of sites. The first spoke may be an active spoke and each spoke in the plurality of the spokes other than the first spoke may be a backup spoke, such that a communication pathway from first spoke of the first vessel to the first hub of the plurality of hubs of the first site is an active communication pathway, and such that the first hub of the first site is an active hub and the first site is an active site. The system may further include a communications protocol wherein each spoke of the plurality of spokes maintains a communication data set relating to communications parameters, which are communicated throughout the system as follows: (1) from each spoke in the vessel to other spokes in the plurality of spokes, including from the first spoke to the second spoke; (2) from each spoke to its respective paired hub in the active site; (3) between each of the hubs of the plurality of hubs of the active site; and (4) between each of the hubs of the plurality of hubs of the plurality of sites that is paired with the active spoke.

In another embodiment, a method for a grid communication protocol for a communication network comprising a plurality of access-point sites, including first site and a second site, wherein each of the sites of the plurality of sites comprises a plurality of hubs including a first hub and a second hub, and a first vessel comprising a plurality of spokes, including a first spoke and a second spoke, wherein each spoke of the plurality of spokes is paired with a hub from the plurality of hubs such that the first spoke is paired with the first hub of each of the sites in the plurality of sites, and the second spoke is paired with the second hub of each of the sites in the plurality of sites, the method may include selecting an active communication path from the first spoke to the first hub of the first site such that the first spoke is an active spoke and each spoke in the plurality of the spokes other than the first spoke is a backup spoke, and such that the first hub of the first site is an active hub and the first site is an active site. Each spoke of the plurality of spokes may maintain a communication data set relating to communications parameters, which may be communicated as follows: (1) from each spoke in the vessel to other spokes in the plurality of spokes, including from the first spoke to the second spoke and vice versa; (2) from each spoke to its respective paired hub in the active site; (3) between each of the hubs of the plurality of hubs of the active site; and (4) between each of the hubs of the plurality of hubs of the plurality of sites that is paired with the active spoke.

In further embodiment, a method for sharing an IP address between spokes may include: generating a DHCP MAC Address; requesting an IP address via DHCP using the DHCP MAC Address; providing the DHCP MAC Address to the spokes; configuring the spokes to use the DHCP MAC Address as their DHCP client identifier value in all DHCP requests; enabling DHCP-enabled channel interfaces when a spoke becomes active; and disabling DHCP-enabled channel interfaces when a spoke enters stand-by or inactive states.

Other example aspects of the present disclosure are directed to systems, apparatus, tangible, non-transitory computer-readable media, user interfaces, memory devices, and electronic devices for conveying the results of questions that require database queries.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

The drawings set forth exemplary embodiments of the disclosed concepts and are not intended to be limiting in any way.

FIG. 1 illustrates an embodiment of a system a grid communication protocol.

FIG. 2 illustrates a method for a grid communication protocol.

FIG. 3 illustrates a method for sharing an IP address across spokes.

### DETAILED DESCRIPTION

The following detailed description and the appended drawings describe and illustrate some embodiments for the purpose of enabling one of ordinary skill in the relevant art to make use the invention. As such, the detailed description and illustration of these embodiments are purely illustrative in nature and are in no way intended to limit the scope of the invention, or its protection, in any manner. It should also be understood that the drawings are not necessarily to scale and in certain instances details may have been omitted, which are not necessary for an understanding of the disclosure, such as details of fabrication and assembly. In the accompanying drawings, like numerals represent like components.

The present disclosure relates to a grid redundancy protocol (“GRP”) for communication networks generally, but more specifically to communication networks with mobile components and access-point components. For example a communication network for a fleet of vehicles or ships having brick-and mortar control stations or data centers. The access-point components are referred to generally as “sites,” which have one or more communication end points (“hubs”) that are used for redundant communication. Persons of skill in the art will note that while the access points in most scenarios are stationary, mobile access points are possible. For example, an aircraft carrier and a cruiser could serve as communication access-points for a fleet of ships and airplanes. Similarly, the mobile components are referred to herein as “vessels” and have one or more communication end points (“spokes”). In the broadest sense, the Grid Redundancy Protocol (GRP) maintains communication pathways that exchange states and statistics (i) between spokes; (ii) between spokes and hubs; and (iii) between hubs. Generally, inputs relating to conditions at each spoke are collected by each spoke and a decision is computed as to which spoke will become active and which site will be used. A communication network may include at least two sites, each having at least two hubs, and one or more vessels, each having at least two spokes. Each site may have an active hub and one or more backup hubs. Likewise each vessel may have an active spoke and one or more backup spokes. The spokes on each vessel may select one of the sites to be its primary communication site, and the other sites may be its backup sites. During normal operation the active spoke-to-hub communication pathway from the vessel to the selected site is from the active spoke on the vessel to the active hub on the site.

If the active spoke-to-hub communication fails, a backup spoke may take over the active role. Various scenarios could trigger an active spoke-to-hub communication failure including: spoke failure, hub failure, or communication path interruption between spoke and hub. The active spoke may select a primary site. The active spoke shares the selected site information with the backup spokes on the vessel. When a backup spoke becomes active, the spoke may attempt to continue to use the same selected primary site to attempt communication. If the new active spoke is unable to communicate with the primary site for a threshold period of time, the active spoke may initiate a connection to a backup site. The active spoke may share the new site details via the GRP protocol.

A major concern in parallel active/backup networking solutions is split-brain, which is to say when the sites and the vessels do not agree on what the active communication path may be. To prevent split-brain, the GRP utilizes multiple paths to communicate the current roles (i.e., which hubs/nodes are active or backup). The primary path for spokes to communicate their current role via the GRP running between Spokes. When this path is not available, there is risk that a split-brain scenario could occur. To prevent this, spokes also share their GRP role from spoke to hub, which may be passed along from hub to hub and then from hub to spoke. When a backup spoke cannot communicate to its peer spoke(s), the backup spoke may become active. If the communication failure occurs between two otherwise healthy spokes, then both spokes will be active. The disclosed GRP utilizes the described secondary communication path to distribute the current spoke roles. When an active spoke receives a GRP message that its peer is also active, each spoke will individually compute which spoke should remain active and which spoke should transition to backup.

In an embodiment a communication system may include a plurality of access-point sites, including first site and a second site, wherein each of the sites of the plurality of sites may include a plurality of hubs including a first hub and a second hub. The communication system may further include a first vessel that may include a plurality of spokes, including a first spoke and a second spoke, where each spoke of the plurality of spokes is paired with a hub from the plurality of hubs such that the first spoke is paired with the first hub of each of the sites in the plurality of sites, and the second spoke is paired with the second hub of each of the sites in the plurality of sites. The first spoke may be an active spoke and each spoke in the plurality of the spokes other than the first spoke may be a backup spoke, such that a communication pathway from first spoke of the first vessel to the first hub of the plurality of hubs of the first site is an active communication pathway, and such that the first hub of the first site is an active hub and the first site is an active site. The system may further include a communications protocol wherein each spoke of the plurality of spokes maintains a communication data set relating to communications parameters, which are communicated throughout the system as follows: (1) from each spoke in the vessel to other spokes in the plurality of spokes, including from the first spoke to the second spoke; (2) from each spoke to its respective paired hub in the active site; (3) between each of the hubs of the plurality of hubs of the active site; and (4) between each of the hubs of the plurality of hubs of the plurality of sites that is paired with the active spoke.

In certain embodiments, a first parameter of the communication parameters may be selected from the group consisting of current state, number of connected channels, calculated per-channel latency, identifier of connected site, current site disconnect timer, estimated bandwidth per channel, and health status. In certain embodiments, when the first spoke loses communication with the first hub of the first site for a threshold amount of time, the second spoke of the plurality of spokes on the vessel attempts to communicate to its paired hub on the active site, the second hub of the first site, and if successful elects to become an active spoke, and communicates same to the first spoke. In certain embodiments, when the first spoke regains communication with the first spoke at approximately the same time the second spoke elects to become the active spoke, the first spoke communicates its active status to the second spoke, causing a conflict that is resolved with either the first spoke or the second spoke, but not both, remaining the active spoke. In certain embodiments, the conflict may be resolved based at least in part on the data set communicated by the spokes. In certain embodiments, the conflict may be resolved based at least in part on a configured priority value for the first spoke and a configured priority value for the second spoke.

In certain embodiments, when the second spoke loses communication with the first spoke for a threshold amount of time, the second spoke elects to become an active spoke and selects a new active communication path. In certain embodiments, the new active communication path comprises the second hub of the first site. In certain embodiments, a conflict is created when the first spoke remains active and the second hub elects to be the active spoke, wherein the second spoke communicates its becoming the active spoke to the second hub of the first site, which in turn communicates the same to the first hub causing the conflict to be detected. In certain embodiments, the conflict may be communicated back to the first spoke and the second spoke for resolution. In certain embodiments, the new active communication path comprises the second hub of the second site. In certain embodiments, a conflict may be created when the first spoke remains active and the second spoke elects to be the active spoke, wherein the second spoke communicates its becoming the active spoke to the second hub of the second site, which in turn communicates the same to the second hub of the first site, which in turn communicates same to the first hub of the first site causing the conflict to be detected. In certain embodiments, the conflict may be communicated back to the first spoke and the second spoke for resolution.

In certain embodiments, when the first spoke loses communication with the first hub of the first site for a threshold amount of time, the second spoke of the plurality of spokes on the vessel attempts to communicate to its respective paired hubs on the plurality of sites, and if successful elects to become an active spoke with a new active communication pathway, and communicates same to the first spoke.

In an embodiment, a method for a grid communication protocol for a communication network comprising a plurality of access-point sites, including first site and a second site, wherein each of the sites of the plurality of sites comprises a plurality of hubs including a first hub and a second hub, and a first vessel comprising a plurality of spokes, including a first spoke and a second spoke, wherein each spoke of the plurality of spokes is paired with a hub from the plurality of hubs such that the first spoke is paired with the first hub of each of the sites in the plurality of sites, and the second spoke is paired with the second hub of each of the sites in the plurality of sites, the method may include selecting an active communication path from the first spoke to the first hub of the first site such that the first spoke is an active spoke and each spoke in the plurality of the spokes other than the first spoke is a backup spoke, and such that the first hub of the first site is an active hub and the first site is an active site. Each spoke of the plurality of spokes may maintain a communication data set relating to communications parameters, which may be communicated as follows: (1) from each spoke in the vessel to other spokes in the plurality of spokes, including from the first spoke to the second spoke and vice versa; (2) from each spoke to its respective paired hub in the active site; (3) between each of the hubs of the plurality of hubs of the active site; and (4) between each of the hubs of the plurality of hubs of the plurality of sites that is paired with the active spoke.

In certain embodiments, a first parameter of the communication parameters may be selected from the group consisting of current state, number of connected channels, calculated per-channel latency, identifier of connected site, current site disconnect timer, estimated bandwidth per channel, and health status. In certain embodiments, the method may further include detecting an interruption of the active communication path, and the second spoke deciding that it is an active spoke, picking a new active communication path, updating the respective communication data set to reflect same and communicating the respective communication data set to other spokes in the plurality of spokes and to the respective paired hub in the new active communication path. In certain embodiments, the method may further include detecting a conflict where the first spoke and second spoke both claim to be the active spoke and communicating the conflict to the first and second spoke. In certain embodiments, the conflict may be resolved based at least in part on the data set communicated by the spokes. In certain embodiments, the conflict may be resolved based at least in part on a configured priority value for the first spoke and a configured priority value for the second spoke.

In certain embodiments, when the second spoke loses communication with the first spoke for a threshold amount of time, the second spoke elects to become an active spoke and selects a new active communication path. In certain embodiments, the new active communication path may include the second hub of the first site. In certain embodiments, a conflict may be created when the first spoke remains active and the second hub elects to be the active spoke, wherein the second spoke communicates its becoming the active spoke to the second hub of the first site, which in turn communicates the same to the first hub causing the conflict to be detected. In certain embodiments, the conflict may be communicated back to the first spoke and the second spoke for resolution. In certain embodiments, the new active communication path may include the second hub of the second site. In certain embodiments, a conflict may be created when the first spoke remains active and the second spoke elects to be the active spoke, wherein the second spoke communicates its becoming the active spoke to the second hub of the second site, which in turn communicates the same to the second hub of the first site, which in turn communicates same to the first hub of the first site causing the conflict to be detected. In certain embodiments, the conflict is communicated back to the first spoke and the second spoke for resolution.

In certain embodiments, when the first spoke loses communication with the first hub of the first site for a threshold amount of time, the second spoke of the plurality of spokes on the vessel attempts to communicate to its respective paired hubs on the plurality of sites, and if successful elects to become an active spoke with a new active communication pathway, and communicates same to the first spoke.

In an embodiment, a method for sharing an IP address between spokes may include: generating a DHCP MAC Address; requesting an IP address via DHCP using the DHCP MAC Address; providing the DHCP MAC Address to the spokes; configuring the spokes to use the DHCP MAC Address as their DHCP client identifier value in all DHCP requests; enabling DHCP-enabled channel interfaces when a spoke becomes active; and disabling DHCP-enabled channel interfaces when a spoke enters stand-by or inactive states.

In certain embodiments, the method may further include allowing non-DHCP enabled channel interfaces to remain enabled when the spokes enter standby or inactive states.

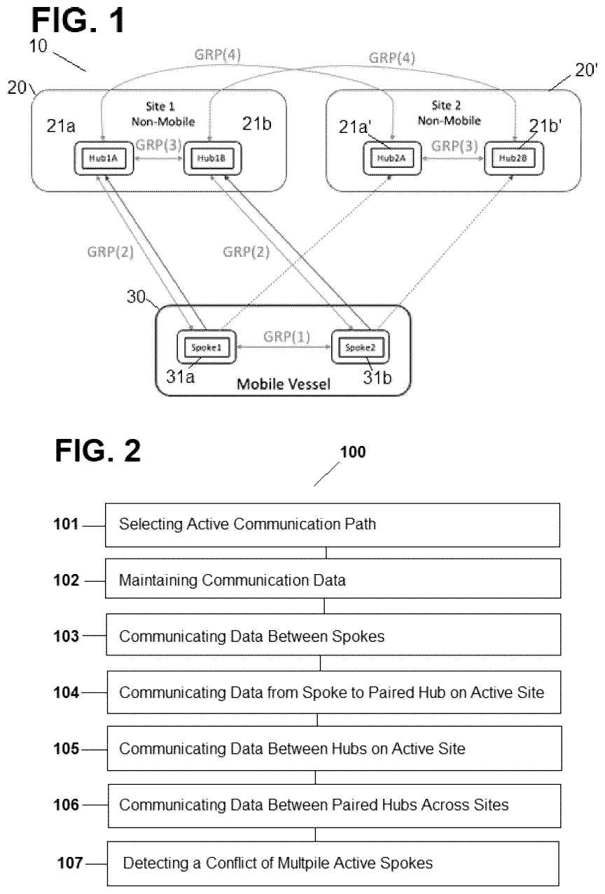

FIG. 1 illustrates a communication system 10 in accordance with the disclosed embodiments. The communication system 1 may include two or more access-point sites 20, 20′ each having at least two communication nodes, hubs 21a, 21b, 21a′, 21b′, and one or more vessels 30, each having at least two communication nodes, spokes 31a, 31b. Each spoke on a vessel 30 may be paired with a hub on the access-point sites. For example, the spoke Spoke1 31a on a vessel 30 may be paired with hub Hub1A 21a of Site1 20, and with hub Hub2A 21a′ of site Site2 20′. As shown in FIG. 1, site Site1 20 is the selected primary site for vessel 30. Accordingly, the GRP includes GRP(1): communications between the spokes 31a, 31b of each vessel; GRP(2): communication between the spokes of the vessel 31a, 31b, and the hubs 21a, 21b, 21a′, 21b′, of the sites 20, 20′; GRP(3): communication between the hubs 21a-21b, 21a′-21b′, and GRP(4) communication between the paired hubs 21a-21a′, 21b-21b′.

The information tracked and communicated by the spokes may include the following: current state (active or backup); number of connected channels; calculated per-channel latency; identifier for the connected site; the current site disconnect timer; estimated bandwidth per channel, network manager connection state; health status (i.e. CPU usage, memory usage, disk space usage, load factor). Sites 20, 20′ may further track and keep any of the information tracked and communicated by the spokes as well as, the following: the current state of remote paired hub and remote paired hub peer.

During operation the vessel's 30 spokes 31a, 31b use the tracked information to determine which spoke should be the active spoke, and which hub 21a, 21b, 21a′, 21b′ paired to the active spoke to use to establish the communication path for the vessel 30. This decision is made programmatically by the spokes based on the tracked information and an algorithm or heuristic implemented to make the decision. Persons of skill in the art will recognize that many different solutions can be used depending upon the resources and need for an implementation. It can be as easy as providing a scoring function that computes a score for each available communication path and selects the highest (or lowest) score, or as complicated as having an artificial intelligence model trained on path selection based on the tracked information and other data that is kept by the vessel to make the decision. Each spoke 31a, 31b may further be configured to have a priority value assigned to each spoke 31a, 31b based on its ability to communicate to its respective remote hubs 21a, 21b, 21a′, 21b′ and/or other factors, age, performance history, etc. If no spoke 31a, 31b is active and all spokes are able to connect to their paired remote hubs 21a, 21b, 21a′, 21b′, then the spoke with the highest priority will become active and the spoke(s) with lower priority will become standby. Once the decision is made, an active communication path is established between the active spoke, Spoke1 31 in FIG. 1, and its paired hub on the selected site, hub Site1 21a.

The spokes may periodically repeat this process to account for a change in parameters as a result of normal operation. For example, if vessel 30 has moved further away from access-point site 20 and closer to site 20′, then the evaluation function for the communication paths may favor swapping communications paths to a more efficient pathway. Thus, the spokes 31a, 31b may negotiate which remote site to use. At startup, this selection may be based purely on a configured priority value. Once a spoke 31a, 31b connects to a hub 21a, 21b, 21a′, 21b′ at an access point site 20, 20′ and a spoke 31a, 31b becomes the active spoke, the access point site 20, 20′ may then be considered the active site for that vessel 30. The active spoke 31a will update the backup spoke(s) 31b via GRP as to which site is the active site 20, so that the backup spoke(s) 31b will know what communication line to attempt first in the event of an interruption of communication (i.e. their respective paired hub 21b at the active site 20).

After the initial connection, the spokes 31a, 31b, individually track their respective connected state to the active site's 20 hubs 21a, 21b. In the mobile Satellite Communication industry, it may desirable to maintain connectivity from the mobile side of the network to the non-mobile side without oscillating between non-mobile sites. Thus, if at least one spoke 31a, 31b is able to maintain a connection to its respective hub 21a, 21b at the active site 20, then both spokes will continue to use that site even if that means that one of the two spokes 31a, 31b is not able to connect to the active site 20. In this case, the spoke 31a that is not able to connect to the active site may communicate its inability to connect to the other spoke(s) 31b on the vessel, and as long as the backup spokes 31b can still communicate with their respective hub 21b at the active site 20, the active site can remain the active site, and the spoke 31b with the best communication path 31b-21b to the active site 20 can become the active spoke. In the interim, the disconnected spoke 31a may continue to attempt to establish a connection to its paired hub 21a on the active site 20. When neither Spoke is able to connect to the active site 20, then one or all of the spokes 31a, 31b may check their connection to one or more of the backup site 20′. If successful, the spokes 31a, 31b may repeat the process to select an active communication pathway to their respective paired hubs 21a′ 21b′ at the backup site(s) 20′. Upon selection of a new communication pathway a spoke 31a, 31b may be assigned as the active spoke and the selected backup site 20′ may become the active site. When this occurs, the spoke that is selected as the active spoke 31b, may inform the other spoke to use the new role. The decision for the selection of the active spoke and/or communication pathway may be made centrally by a computing system on the vessel that communicates the decision to the spokes, or can be made individually by the spokes that have communicated their tracked information to one another and thus should arrive at the same decision in a properly implemented system.

In the event that two or more spokes 31a, 31b make the decision about which spoke 31a, 31b will be active they may communicate this conflict with one another and the spoke 31a, 31b with the higher configured priority value should remain the active spoke while the other spoke returns to a backup spoke role. Accordingly, the opportunity for a split-brain scenario occurs when the two spokes cannot communicate with each other, such as when communication within the vessel has been disrupted. In this event, each spoke 31a, 31b will still communicate its decision to become the active spoke to the hub which it is paired with in the newly active communication path that the spoke is establishing. For example, if two spokes 31a, 31b cannot communicate with each other and decide to be the active spoke with their respective paired spoke 21a′, 21b′ respectively, of site 20′, both spokes will communicate this decision to their respective hub 21a′, 21b′ at site 20′. This conflict will be discovered when under the GRP the hubs 21a′ and 21b′ communicate this message with each other within site 20′. The conflict may then be communicated back to both spokes 31a, 31b with any relevant tracked information needed for them to resolve the conflict and have one spoke remain active and the other return to a backup role. The same will happen even if the two spokes choose an active communication path on separate sites 20, 20′. For example if two spokes 31a, 31b cannot communicate and decide to be the active spoke with spoke 31a electing a communication path through hub 21a of site 20 and spoke 31b electing a communication path through hub 21b′ of site 20′, the conflict will be discovered after the selected hubs 21a, 21b′ communicate this information with respective on-site hubs 21b, 21a′, respectively and with their paired hubs at the other access point site, hubs 21a′ and 21b, respectively. Put another way, the non-elected hubs 21a′ and 21b will receive conflicting active hub messages from their paired and on-site hub partners. Hub 21a′ will receive a communication from its paired hub hub 21a that spoke 31a is the active hub and the conflicting message from its on-site hub neighbor hub 21b′ that spoke 31b is the active hub. This conflict and the related tracked information can then be communicated back to the spokes 31a, 31b for resolution.

Thus, the redundant communication of the GRP ensures detection of circumstances where two or more hubs 21a, 21b at a site 20 are reporting active, where two or more spokes 31a, 31b on a vessel 30, or when two or more spoke-to-hub communication pathways 31a-21a, 31b-21b′ across all sites 20, 20′ are reporting as active for that vessel 30. In any of these cases, when the conflict is detected each ‘active’ hub would report to its connected spoke via GRP that another spokes is active, together with any tracked information necessary to resolve the conflict. Once reported, the Spoke with the calculated value, and/or the higher configured priority will remain active and the other spoke can return to a backup role until communication is re-established between the Spokes.

Some deployments use the same local access network (LAN) side IP addresses for each spoke and/or hub. In such a scenario, GRP may disable the LAN side interfaces on the spoke and/or hub when transitioning to a standby state. GRP may also enable LAN side interfaces on the spoke and/or hub when transitioning to and active state. GRP may additionally send a gratuitous address resolution protocol (ARP) for each LAN side IP address when GRP enables a LAN side interface.

The active spoke may share its calculated bandwidth estimation values on a per channel basis. When a backup spoke takes over the active role, the backup spoke that is transitioning to be the active spoke may use the calculated bandwidth estimation values as a starting point. This may greatly increases the accuracy of the bandwidth estimation in the first few minutes of a spoke becoming active.

FIG. 2 illustrates a method for a grid communication protocol 100. The method may be implemented on a communication network having two or more access-point sites, including first site and a second site, where each of the sites may include two or more hubs, including a first hub and a second hub. The communication network may further include a vessel having a two or more of spokes, including a first spoke and a second spoke, such that each spoke is paired with a hub at each site. For example, the first spoke may be paired with the first hub of each of the sites, and the second spoke may be paired with the second hub of each of the sites. The grid communication protocol method 100 may include selecting an active communication path 101; maintaining communication data 102; communicating data between spokes on the vessel 103; communication data between the spokes and their respective paired hub on the active site 104; communicating data between the two or more hubs on the active site 105; communicating data between paired hubs across 106; and detecting a conflict of multiple active spokes 107.

Selective an active communication path 101 is the process by which an initial communication path is selected, as described above, whereby the spokes communicate and decide which spoke will be the active spoke, and which site and corresponding paired hub will be part of the active communication pathway. The spokes may make this election, as discussed above, based on a score generated from an initial set of communication data, such as test communications to ensure that they can communicate with at least one hub at one site, or absent such it maybe made based on their respective configured priority value, or both (for example the configured priority value may be used to break ties resulting from a score generated by an algorithm or heuristic). Selection of the active communication pathway selects an active spoke, an active hub at an active site, and relegates the other spokes and hubs as inactive backups. Maintaining communication data 102 involves each spoke tracking its respective communication data, which may include but is not limited to current state (active or backup); number of connected channels; calculated per-channel latency; identifier for the connected site; the current site disconnect timer; estimated bandwidth per channel, network manager connection state; health status (i.e. CPU usage, memory usage, disk space usage, load factor). Communicating data between spokes on the vessel 103 is the first leg of the GRP discussed above, whereby spokes communicate their respective communication data to other spokes on the vessel so that spokes can ensure that the communications grid is operating normally, as intended. Where something is out of order, such as the active spoke losing communication with its paired hub on the active site, a new spoke may begin the process of becoming an active spoke, as discussed above. This also allows detection of conflicts between spokes locally on the vessel when two spokes claiming active status on the vessel can communicate with one another. Communication data between the spokes and their respective paired hub on the active site 104 is the second leg of the GRP discussed above whereby spokes communicate their respective communication data, including new claims of being the active spoke, to their paired hub on the active site. This allows a new spoke to claim active status with the active site when communication has broken down between the active spoke and its paired hub on the active site. Communicating data between the two or more hubs on the active site 105 is the third leg of the GRP discussed above, wherein hubs at the active site share the communication data they receive from their respective spokes. This, in combination with the spoke-to-hub communication 104 allows conflict detection of multiple active spokes where the spokes are unable to communicate with one another locally on the vessel. Communicating data between paired hubs across 106 is the fourth leg of the GRP discussed above, whereby the hubs paired with the active spoke across all sites communicate the communication data with each other. As discussed above this, in combination with the intra-site hub communication 104, allows for detection of a conflict of multiple active spokes where a new active communication pathway with a second site is begun while the current active communication pathway is being maintained. Detecting a conflict of multiple active spokes 107 When a conflict is detected where multiple spokes are claiming to be the active spoke, the communication processes 103, 104, 105, 106 can generate a conflict message to be propagated back to the spokes that are claiming to be the active spoke so that the conflict can be resolved. As with picking the active communication path, a conflict can be resolved by using an algorithm or heuristic on the respective communication data to pick the most efficient communication path, or by using a configured priority value, or through both.

In some implementations, an access point, such as a site 20, 20′ may require a connected vessel 30 to obtain an IP address via DHCP. The same access point may only support one Public IP address which is bound to one Mac address until it is restarted. In these circumstances the two or more spokes 31a, 31b onboard a vessel 30 may have to share the IP address supplied via DHCP.

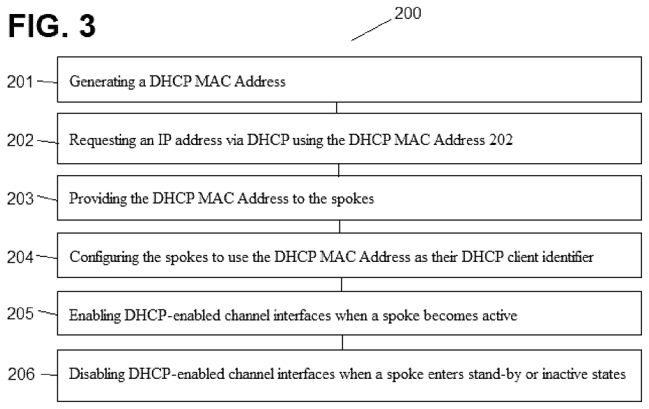

FIG. 3 illustrates a method for sharing an IP address between the spokes of a vessel 200. The method for sharing an IP address obtained by DHCP 200 may include: generating a DHCP MAC Address 201; requesting an IP address via DHCP using the DHCP MAC Address 202; providing the DHCP MAC Address to the spokes 203; configuring the spokes to use the DHCP MAC Address as their DHCP client identifier value in all DHCP requests 204; enabling DHCP-enabled channel interfaces when a spoke becomes active 205, and disabling DHCP-enabled channel interfaces when a spoke enters stand-by or inactive states 206.

The DHCP MAC Address can be any suitable MAC address and does not need to be the actual MAC address of any of the spokes 31a, 31b. The shared DHCP MAC address should be globally unique to the group of spokes 31a, 31b it is being assigned to. The request for the IP address may include the DHCP MAC Address in the “CHADDR” field of the DHCP packet. DHCP requests may be sent as an IP broadcast message. The DHCP RFC requires that a DHCP server reply to any unicast request with a unicast response AND that the unicast response must use the MAC address specified in the DHCP chaddr field. If a DHCP MAC Address has not been configured, then the spokes may use their respective configured name concatenated it with the interface's sw_if_index value for the DHCP client identifier.

Non-DHCP enabled channel interfaces may remain enabled when the spokes enter the standby state. This may allow channels traversing a non-DHCP enabled interface to remain connected. These connected channels may allow the detection of multiple spokes in a group being simultaneously active. DHCP-enabled channel interfaces and/or channel sub-interfaces may be disabled when a spoke enters the Standby state. DHCP-enabled channel interfaces and/or channel sub-interfaces may be enabled when the Spoke enters the Active state. DHCP-enabled channel interfaces and/or channel sub-interfaces may send a DHCP Discover request when the spoke enters the active state. DHCP-enabled channel interfaces and/or channel sub-interfaces may send multiple address resolution protocol messages (ARPs) when the spoke enters the active state. DHCP-enabled channel interfaces and/or channel sub-interfaces may periodically send an ARP when the spoke is in the active state.

In some implementations a non-transitory, computer-readable medium may contain instructions that when executed by the processor cause the processor to perform any of the methods described herein.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

I claim:

1. A communication system comprising:
a plurality of access-point sites, including first site and a second site, wherein each of the sites of the plurality of sites comprises a plurality of hubs including a first hub and a second hub;
a first vessel comprising a plurality of spokes, including a first spoke and a second spoke, wherein each spoke of the plurality of spokes is paired with a hub from the plurality of hubs such that the first spoke is paired with the first hub of each of the sites in the plurality of sites, and the second spoke is paired with the second hub of each of the sites in the plurality of sites;
wherein the first spoke is an active spoke and each spoke in the plurality of the spokes other than the first spoke is a backup spoke, and wherein the communication pathway from first spoke of the first vessel to the first hub of the plurality of hubs of the first site is an active communication pathway such that the first hub of the first site is an active hub and the first site is an active site;
a communications protocol wherein each spoke of the plurality of spokes maintains a communication data set relating to communications parameters, which are communicated throughout the system as follows:
1. from each spoke in the vessel to other spokes in the plurality of spokes, including from the first spoke to the second spoke;
2. from each spoke to its respective paired hub in the active site;
3. between each of the hubs of the plurality of hubs of the active site; and
4. between each of the hubs of the plurality of hubs of the plurality of sites that is paired with the active spoke.

2. The system of claim 1 wherein a first parameter of the communication parameters is selected from the group consisting of current state, number of connected channels, calculated per-channel latency, identifier of connected site, current site disconnect timer, estimated bandwidth per channel, and health status.

3. The system of claim 1 wherein when the first spoke loses communication with the first hub of the first site for a threshold amount of time, the second spoke of the plurality of spokes on the vessel attempts to communicate to its paired hub on the active site, the second hub of the first site, and if successful elects to become an active spoke, and communicates same to the first spoke.

4. The system of claim 3 wherein when the first spoke regains communication with the first spoke at approximately the same time the second spoke elects to become the active spoke, the first spoke communicates its active status to the second spoke, causing a conflict that is resolved with either the first spoke or the second spoke, but not both, remaining the active spoke.

5. The system of claim 4 wherein the conflict is resolved based at least in part on the data set communicated by the spokes.

6. The system of claim 4 wherein the conflict is resolved based at least in part on a configured priority value for the first spoke and a configured priority value for the second spoke.

7. The system of claim 1 wherein when the second spoke loses communication with the first spoke for a threshold amount of time, the second spoke elects to become an active spoke and selects a new active communication path.

8. The system of claim 7 wherein the new active communication path comprises the second hub of the first site.

9. The system of claim 8 wherein a conflict is created when the first spoke remains active and the second hub elects to be the active spoke, wherein the second spoke communicates its becoming the active spoke to the second hub of the first site, which in turn communicates the same to the first hub causing the conflict to be detected.

10. The system of claim 9 wherein the conflict is communicated back to the first spoke and the second spoke for resolution.

11. The system of claim 7 wherein the new active communication path comprises the second hub of the second site.

12. The system of claim 11 wherein a conflict is created when the first spoke remains active and the second spoke elects to be the active spoke, wherein the second spoke communicates its becoming the active spoke to the second hub of the second site, which in turn communicates the same to the second hub of the first site, which in turn communicates same to the first hub of the first site causing the conflict to be detected.

13. The system of claim 12 wherein the conflict is communicated back to the first spoke and the second spoke for resolution.

14. The system of claim 1 wherein when the first spoke loses communication with the first hub of the first site for a threshold amount of time, the second spoke of the plurality of spokes on the vessel attempts to communicate to its respective paired hubs on the plurality of sites, and if successful elects to become an active spoke with a new active communication pathway, and communicates same to the first spoke.

15. A method for a grid communication protocol for a communication network comprising a plurality of access-point sites, including first site and a second site, wherein each of the sites of the plurality of sites comprises a plurality of hubs including a first hub and a second hub, and a first vessel comprising a plurality of spokes, including a first spoke and a second spoke, wherein each spoke of the plurality of spokes is paired with a hub from the plurality of hubs such that the first spoke is paired with the first hub of each of the sites in the plurality of sites, and the second spoke is paired with the second hub of each of the sites in the plurality of sites, the method comprising:
selecting an active communication path from the first spoke to the first hub of the first site such that the first spoke is an active spoke and each spoke in the plurality of the spokes other than the first spoke is a backup spoke, and such that the first hub of the first site is an active hub and the first site is an active site;
wherein each spoke of the plurality of spokes maintains a communication data set relating to communications parameters, which are communicated as follows:
1. from each spoke in the vessel to other spokes in the plurality of spokes, including from the first spoke to the second spoke and vice versa;
2. from each spoke to its respective paired hub in the active site;
3. between each of the hubs of the plurality of hubs of the active site; and
4. between each of the hubs of the plurality of hubs of the plurality of sites that is paired with the active spoke.

16. The method of claim 15 wherein a first parameter of the communication parameters is selected from the group consisting of current state, number of connected channels, calculated per-channel latency, identifier of connected site, current site disconnect timer, estimated bandwidth per channel, and health status.

17. The method of claim 15, further comprising detecting an interruption of the active communication path, and the second spoke deciding that it is an active spoke, picking a new active communication path, updating the respective communication data set to reflect same and communicating the respective communication data set to other spokes in the plurality of spokes and to the respective paired hub in the new active communication path.

18. The method of claim 16 further comprising detecting a conflict where the first spoke and second spoke both claim to be the active spoke, and communicating the conflict to the first and second spoke.

19. A method for sharing an IP address between spokes comprising:
generating a DHCP MAC Address;
requesting an IP address via DHCP using the DHCP MAC Address;
providing the DHCP MAC Address to the spokes;
configuring the spokes to use the DHCP MAC Address as their DHCP client identifier value in all DHCP requests;
enabling DHCP-enabled channel interfaces when a spoke becomes active; and
disabling DHCP-enabled channel interfaces when a spoke enters stand-by or inactive states.

20. The method of claim 19 further comprising allowing non-DHCP enabled channel interfaces to remain enabled when the spokes enter standby or inactive states.
